(19) United States
(12) Patent Application Publication
(10) Pub. No.: US 2024/0334096 A1
(43) Pub. Date: Oct. 3, 2024

(54) OPTICAL NETWORK SYSTEM, RELAY DEVICE, TRANSMISSION DEVICE, RECEPTION DEVICE, AND OPTICAL NETWORK CONTROL DEVICE

(71) Applicant: Sony Group Corporation, Tokyo (JP)

(72) Inventors: Hiroshi MORITA, Kanagawa (JP); Kazuaki TOBA, Kanagawa (JP); Masanari YAMAMOTO, Kanagawa (JP)

(73) Assignee: Sony Group Corporation, Tokyo (JP)

(21) Appl. No.: 18/580,061

(22) PCT Filed: Mar. 15, 2022
(86) PCT No.: PCT/JP2022/011693

§ 371 Date: Jan. 17, 2024

(30) Foreign Application Priority Data
Aug. 4, 2021 (JP) 2021-128263

(51) Int. Cl. H04Q 11/00

(52) U.S. Cl. CPC H04Q 11/0067; H04Q 11/0005; H04Q 2011/0016; H04Q 2011/0073; H04Q 2213/02

(57) ABSTRACT

To make it possible to convert transmission data from a transmission device into a data amount corresponding to a communication speed of a path and transmit the same to a reception device without causing an increase in power and an increase in latency. A path from a transmission device to a reception device is constructed by an optical network control device. At least any one of a predetermined number of relay devices included in the constructed path includes a data conversion unit configured to reduce a data amount of transmission data as an optical signal as it is. The optical network control device controls the data reduction amount in the data amount conversion unit on the basis of the communication speed of the constructed path.

### TECHNICAL FIELD

The present technology relates to an optical network system, a relay device, a transmission device, a reception device, and an optical network control device, and more particularly relates to the optical network system and the like in which the optical network control device constructs a path from the transmission device to the reception device.

### BACKGROUND ART

Conventionally, an optical network system for data transmission is known (refer to, for example, Patent Document 1). Here, an optical network system is considered in which a control device (control center) that manages an optical network constructs a path from a transmission device to a reception device, and thereafter starts data transmission from the transmission device to the reception device.

In such an optical network system, in a case where high-resolution video data is transmitted from the transmission device to a plurality of reception devices, there is a possibility that the high-resolution video data cannot be received depending on a communication speed of the path.

Therefore, for example, in MPEG-DASH and the like, a technology is proposed in which a plurality of resolution compressed video data is prepared for original high-resolution video data by a cloud data center and the like on an optical network to transmit optimal video data according to the communication speed of the path.

However, in this case, electrical conversion and data processing for resolution compression are required in the cloud data center, an increase in used power and an increase in latency occur.

### CITATION LIST

### Patent Document

Patent Document 1: WO 2017/057152

### SUMMARY OF THE INVENTION

### Problems to be Solved by the Invention

An object of the present technology is to make it possible to convert transmission data from a transmission device into a data amount corresponding to a communication speed of a path and transmit the same to a reception device without causing an increase in power and an increase in latency.

### Solutions to Problems

A concept of the present technology is
an optical network system including:
a transmission device; a reception device; a plurality of relay devices present between the transmission device and the reception device; and an optical network control device that constructs a path from the transmission device to the reception device, in which
at least any one of a predetermined number of the relay devices included in the constructed path includes a data amount conversion unit configured to reduce a data amount of transmission data as an optical signal as it is, and
the optical network control device controls a data reduction amount in the data amount conversion unit on the basis of a communication speed of the constructed path.

The present technology is the optical network system provided with the transmission device, the reception device, a plurality of relay devices present between the transmission device and the reception device, and the optical network control device that constructs the path from the transmission device to the reception device. Here, at least any one of the predetermined number of relay devices included in the constructed path includes the data amount conversion unit configured to reduce the data amount of the transmission data as the optical signal as it is. The optical network control device controls the data reduction amount in the data amount conversion unit on the basis of the communication speed of the constructed path.

For example, the transmission data transmitted from the transmission device may be data the data amount of which is able to be reduced by thinning, and in a case where the data amount of the transmission data is reduced, the data amount conversion unit may reduce the data amount by thinning. Therefore, the data amount conversion unit can easily reduce the data amount by thinning.

In this case, for example, management data for enabling the reception device to determine a data reduction amount by the thinning in the transmission data received by the reception device may be added to the transmission data transmitted from the transmission device. Therefore, the reception device can easily determine the data reduction amount by thinning in the received transmission data, and can appropriately perform processing such as interpolation processing on the transmission data.

For example, the transmission data transmitted from the transmission device may be video data subjected to bit data rearrangement processing for performing the thinning. Therefore, the data amount conversion unit can easily reduce the data amount of the video data by thinning.

In this case, for example, the bit data rearrangement processing may be rearrangement of bit data between a plurality of frames as a set or between a plurality of pixels as a set in a frame. In this case, the data amount can be easily reduced by frame thinning or pixel thinning.

Here, for example, management data for enabling a reception device to determine a frame out of the plurality of frames the bit data of which is first bit data received by the reception device in a case where the bit data rearrangement processing is the rearrangement between the plurality of frames as a set may be added to the transmission data transmitted from the transmission device. Therefore, the reception device can easily determine the frame out of a plurality of frames the bit data of which is the first bit data of the received video data, and can appropriately perform processing such as data accumulation processing and data interpolation processing on the received transmission data.

In this manner, in the present technology, at least any one of a predetermined number of the relay devices included in the constructed path includes a data amount conversion unit configured to reduce a data amount of transmission data as an optical signal as it is on the basis of the communication speed of the path constructed by the optical network control device, and the optical network control device controls a data reduction amount in the data amount conversion unit, and can convert the transmission data from the transmission device to the data amount depending on the communication speed of the path to transmit to the reception device without causing an increase in power and an increase in latency.

Note that, in the present technology, for example, the optical network control device may be configured to control a data reduction amount in the data amount conversion unit on the basis of a capability of the reception device together with the communication speed of the constructed path. Therefore, in the data amount conversion unit, it is possible to more appropriately reduce the data amount in consideration of the capability of the reception device.

Furthermore, another concept of the present technology is
a relay device, including:
a data amount conversion unit that converts a data amount of transmission data, in which
the data amount conversion unit is configured to reduce the data amount of the transmission data as an optical signal as it is.

The present technology includes the data amount conversion unit that converts the data amount of the transmission data. Then, the data amount conversion unit is configured to reduce the data amount of the transmission data as the optical signal as it is. For example, the data amount conversion unit may be formed by using an optical arithmetic circuit.

In this manner, the present technology includes the data amount conversion unit that converts the data amount of the transmission data, and the data amount conversion unit is configured to reduce the data amount of the transmission data as the optical signal as it is and can reduce the data amount of the transmission data to transmit to a next stage without causing an increase in power or an increase in latency.

Note that, in the present technology, for example, the data amount conversion unit may reduce the data amount by thinning in a case of reducing the data amount of the transmission data. Therefore, the data amount conversion unit can easily reduce the data amount by thinning.

Furthermore, the present technology can further include an optical splitter, for example, in which the data amount conversion unit can convert the data amount of the transmission data split by the optical splitter. Therefore, it is possible to reduce the data amount of each of the plurality of split transmission data to output by the data amount conversion unit.

Furthermore, another concept of the present technology is a transmission device including:
a data output unit that outputs transmission data a
data amount of which is able to be reduced by thinning, and
a data transmission unit that transmits the transmission data.

In the present technology, the data output unit outputs transmission data a data amount of which is able to be reduced by thinning. Then, the data transmission unit transmits the transmission data.

In this manner, the present technology outputs the transmission data the data amount of which may be reduced by thinning and transmits the transmission data, and it is possible to easily reduce the data amount of the transmission data by thinning as the optical signal as it is according to the communication speed of the path on the path to the reception device.

Note that, in the present technology, for example, management data for enabling a reception device to determine a data reduction amount by the thinning in the transmission data received by the reception device may be added to the transmission data. Therefore, the reception device can easily determine the data reduction amount by thinning in the received transmission data, and can appropriately perform processing such as interpolation processing on the transmission data.

Furthermore, in the present technology, for example, the transmission data may be video data subjected to bit data rearrangement processing for performing the thinning. Therefore, the data amount of the video data can be easily reduced by thinning according to the communication speed of the path on the path to the reception device.

In this case, for example, the bit data rearrangement processing may be rearrangement of bit data between a plurality of frames as a set or between a plurality of pixels as a set in a frame. In this case, the data amount can be easily reduced by frame thinning or pixel thinning.

Here, for example, management data for enabling a reception device to determine a frame out of the plurality of frames the bit data of which is first bit data received by the reception device in a case where the bit data rearrangement processing is the rearrangement between the plurality of frames as a set may be added to the transmission data. Therefore, the reception device can easily determine a frame bit data of which is first received bit data out of the plurality of frames, and can appropriately perform processing on the received transmission data.

Furthermore, another concept of the present technology is
a reception device including:
a data reception unit that receives transmission data to which management data for determining a data reduction amount is added;
a determination unit that determines the data reduction amount on the basis of the management data; and
a data processing unit that processes the received transmission data on the basis of the determined data reduction amount.

In the present technology, the transmission data to which the management data for determining the data reduction amount is added is received by the reception unit. Furthermore, the determination unit determines the data reduction amount on the basis of the management data. Then, the data processing unit processes the received transmission data on the basis of the determined data reduction amount. For example, the received transmission data may be transmission data transmitted via a data conversion unit configured to reduce a data amount by thinning as an optical signal as it is.

In this manner, in the present technology, the received transmission data is processed on the basis of the data reduction amount determined by the management data added to the transmission data, and it is possible to appropriately perform processing on the received transmission data with respect to the data amount of the received transmission data, for example, accumulation processing, display processing and the like.

Furthermore, another concept of the present technology is:
an optical network control device including:
a path construction unit that constructs a path from a transmission device to a reception device via a predetermined number of relay devices on an optical network, in which
at least any one of the predetermined number of relay devices included in the constructed path includes a data amount conversion unit configured to reduce a data amount of transmission data as an optical signal as it is, and
further includes a data reduction amount control unit that controls a data reduction amount in the data amount conversion unit on the basis of a communication speed of the constructed path.

In the present technology, the path construction unit constructs the path from the transmission device to the reception device via a predetermined number of relay devices on the optical network. Here, at least any one of the predetermined number of relay devices included in the constructed path includes the data amount conversion unit configured to reduce the data amount of the transmission data as the optical signal as it is. The data reduction amount control unit controls the data reduction amount in the data amount conversion unit on the basis of the communication speed of the constructed path.

In this manner, in the present technology, the data reduction amount in the data amount conversion unit configured to reduce the data amount of the transmission data as the optical signal as it is included in at least any one of a predetermined number of relay devices included in the constructed path is controlled on the basis of the communication speed of the constructed path, and the transmission data from the transmission device can be converted into the data amount according to the communication speed of the path and transmitted to the reception device without causing an increase in power or an increase in latency.

Note that, in the present technology, for example, the data reduction amount control unit may be configured to control a data reduction amount in the data amount conversion unit on the basis of a capability of the reception device together with the communication speed of the constructed path. Therefore, in the data amount conversion unit, it is possible to more appropriately reduce the data amount in consideration of the capability of the reception device, for example, the data processing capability, the data accumulation capability, the display capability in a case of the video data and the like.

### BRIEF DESCRIPTION OF DRAWINGS

FIG. 1 is a diagram illustrating an example of an optical network system.

FIG. 2 is a diagram for illustrating an example of a system capable of alleviating limitation on an amount of data that can be communicated.

FIG. 3 is a diagram illustrating an example of the optical network system.

FIG. 4 is a diagram for illustrating an operation of the optical network system in a case where a wavelength division multiplexing system is used.

FIG. 5 is a diagram illustrating an example of a network system in which a device on a transmission side and a device on a reception side are connected via a network.

FIG. 6 is a diagram illustrating an example of a network system in which a device on a transmission side and a device on a reception side are connected via a network.

FIG. 7 is a diagram illustrating a configuration example of an optical network system as an embodiment.

FIG. 8 is a diagram illustrating a configuration example of a switch/router including an optical splitter and a converter.

FIG. 9 is a diagram illustrating a configuration example of a converter.

FIG. 10 is a diagram illustrating a configuration example of original data as the transmission data transmitted from the transmission device.

FIG. 11 is a diagram for illustrating an example of bit rearrangement processing of video data.

FIG. 12 is a diagram for illustrating data amount reduction by thinning for video data after bit data rearrangement.

FIG. 13 is a diagram for illustrating data reduction amount determination data included in management data.

FIG. 14 is a diagram for illustrating data start frame determination data included in management data.

FIG. 15 is a diagram illustrating a configuration example of a transmission device.

FIG. 16 is a diagram illustrating a configuration example of a reception device.

FIG. 17 is a diagram for illustrating processing in a data processing unit of the reception device.

### MODE FOR CARRYING OUT THE INVENTION

Hereinafter, a mode for carrying out the invention (hereinafter referred to as an “embodiment”) will be described. Note that, the description will be given in the following order.
1. Embodiment
2. Variation

### 1. Embodiment

### Description of Related Technology

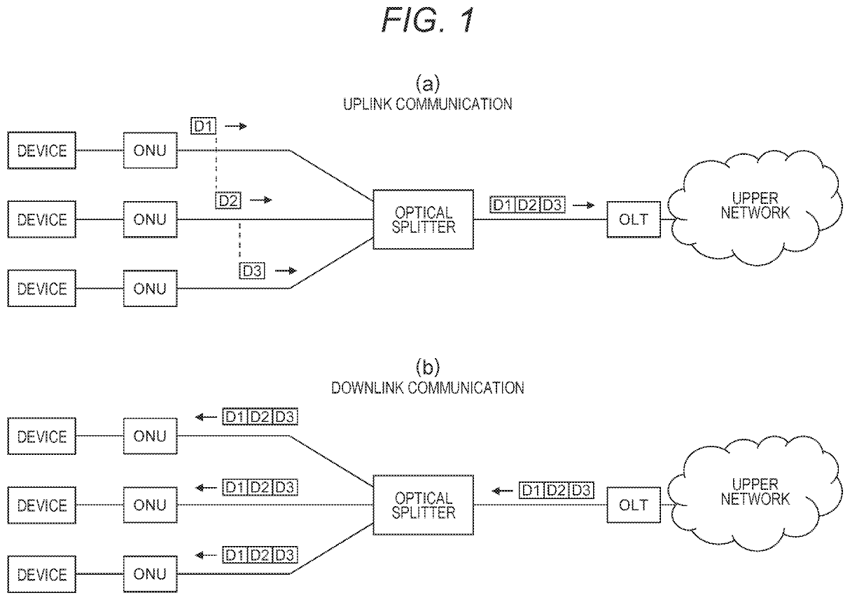

First, a technology related to the present technology will be described. For example, a current network access network such as a passive optical network (PON) is considered. As illustrated in FIG. 1, communication can be performed between an optical line terminal (OLT) on a base station side and optical network units (ONUs) on a side of a plurality of users by using an optical splitter. The OLT is connected to the optical splitter by one fiber, and is connected to respective users with light split by the optical splitter.

In a case of upstream communication as illustrated in FIG. 1(a), data output from the ONU of each user side, which are D1, D2, and D3 in the illustrated example, are multiplexed by the optical splitter. In order to avoid duplication, they are multiplexed in a time axis direction with a data transmission timing and a data transmission amount controlled among the ONUs. In a case of downstream communication as illustrated in FIG. 1(b), data output from the OLT, which is data obtained by multiplexing D1, D2, and D3 in the time axis direction in the illustrated example, is commonly transmitted to the ONU on each user side via the optical splitter. At that time, the ONU on each user side extracts only data addressed to the ONU itself. Note that, wavelengths of optical signals of the upstream communication and the downstream communication are different from each other, so that communication can be performed without interference even if the data overlaps on the time axis.

As described above, in the current network access network, connection between the device on each user side and the network is superimposed (time division multiplexing) in the time axis direction in order to avoid conflict with a large number of devices, and the amount of data that can be communicated is limited.

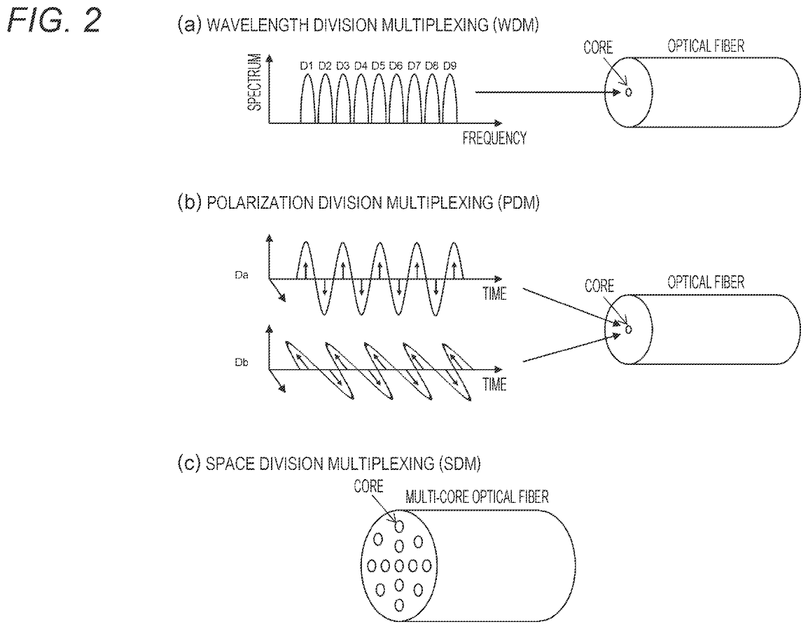

Studies have been conducted to alleviate limitation on the amount of data that can be communicated described above. FIG. 2 illustrates an example of a system capable of alleviating the limitation on the amount of data that can be communicated. FIG. 2(a) illustrates a wavelength division multiplexing (WDM) system, the system that uses a characteristic that light does not interfere when wavelengths are different, adds data to each of a plurality of wavelengths, enables communication of a plurality of data with one optical fiber, and increases the amount of data that can be communicated.

FIG. 2(b) illustrates a polarization division multiplexing (PDM) system, the system that uses a characteristic that light has a component that advances while vertically vibrating and a component that advances while horizontally vibrating, and these two components do not interfere with each other, adds data to each of the two components, enables communication of two data with one optical fiber, and increases the amount of data that can be communicated.

FIG. 2(c) illustrates a space division multiplexing (SDM) system in which a plurality of cores is provided in one optical fiber to enable communication without physical interference of a plurality of data, and increase the amount of data that can be communicated. Note that, by combining these systems, the amount of data that can be communicated can be further increased.

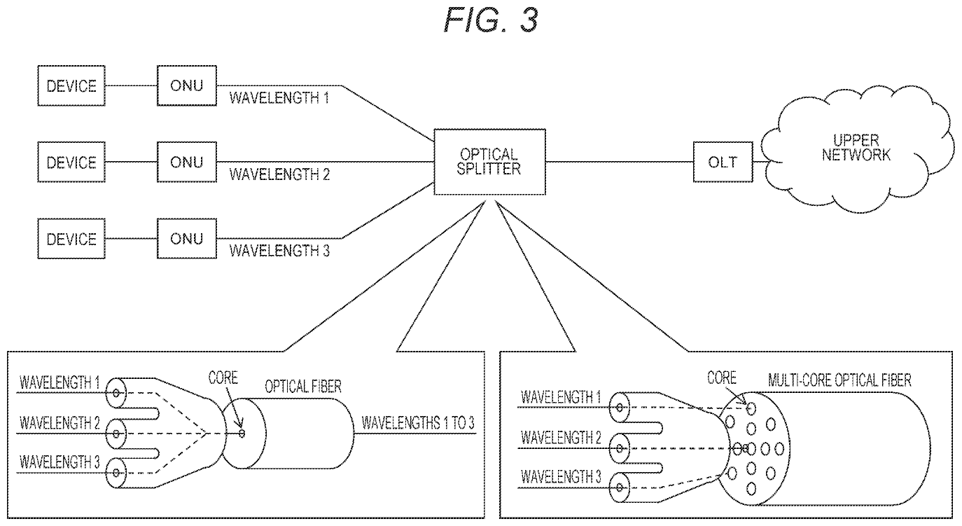

In this manner, a plurality of data can be superimposed on one optical fiber without interfering with each other. For example, in a case where the wavelength division multiplexing system is used, as illustrated in FIG. 3, light rays of a plurality of wavelengths coming from the ONUs can be bundled into one by the optical splitter and transmitted to the OLT side. That is, it is not necessary to perform time division multiplexing, and it is possible to communicate between the ONU and the OLT using each wavelength as a dedicated line. Note that, in a case where the wavelength division multiplexing system and the spatial division multiplexing system are combined using a multi-core optical fiber, a band can be further expanded with an increase in the number of cores.

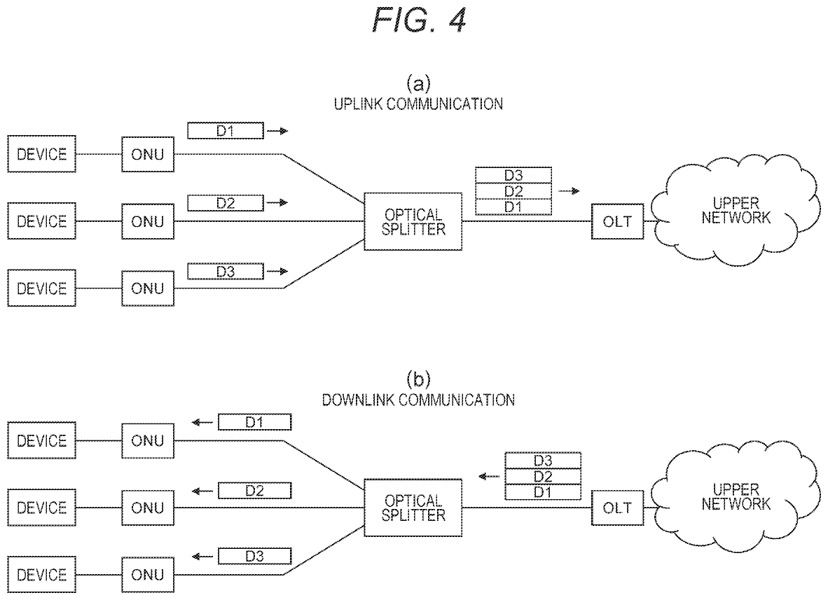

FIG. 4 illustrates an example of communication between the OLT on the base station side and the ONUs on the side of a plurality of users in a case where the wavelength division multiplexing system is used, for example. In a case of uplink communication as illustrated in FIG. 4(a), data output from the ONU on each user side, which are D1, D2, and D3 in the illustrated example, have different wavelengths, so that they do not interfere even when being bundled by the optical splitter, and can be transmitted to the OLT with one fiber. Therefore, the device on each user side can transmit data by fully using a time without taking conflict with other devices into consideration. This is similar in a case of downstream communication as illustrated in FIG. 4(b).

Note that, FIG. 4 illustrates an example of a case where the wavelength division multiplexing system is used, but it is similar in a case where the polarization division multiplexing system or the space division multiplexing system is used, and furthermore, it is similar in a case where the respective systems are used in combination.

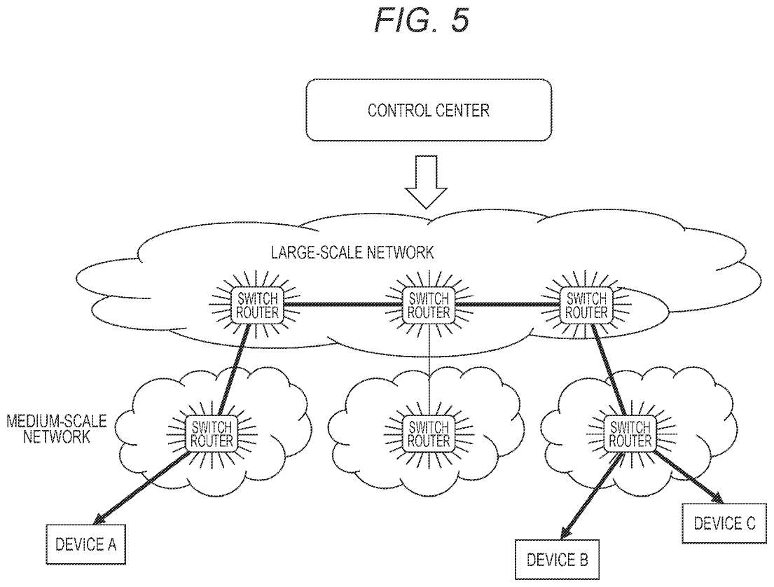

In a case where a system (hereinafter, referred to as a “new network system”) using the above-described wavelength division multiplexing system, polarization division multiplexing system, or space division multiplexing system, or a combination of these systems is implemented, a shape close to peer-to-peer (P2P) connection can also be implemented as the connection between the devices via the network as illustrated in the network system in FIG. 5.

When each switch/router performs path selection, the respective signals are usually bundled, that is, time division multiplexed to be transmitted on an upper layer; however, if the new network system is used, the number of lines that can be used for transmitting as their own dedicated lines dramatically increases, so that the necessity of time division multiplexing is reduced; in an extreme case, the devices via the network can be connected to each other via a dedicated line like P2P connection.

Furthermore, with the progress in optical multiplexing and optical switching technology, a network path can be constructed only with light without using electrical conversion. At that time, since the data transmitted from the device is not electrically converted, the network switch cannot determine connection destination information. Therefore, as illustrated in FIG. 5, the network is managed by a control center as a network control device.

In this case, when the devices are connected, for example, a device A is connected to devices B and C, the device and the control center first communicate with each other, and connection by optical switching is performed on a section wanted to be connected under the control of the control center, so that an optical path as a network path is constructed. Then, the devices start data transmission after that.

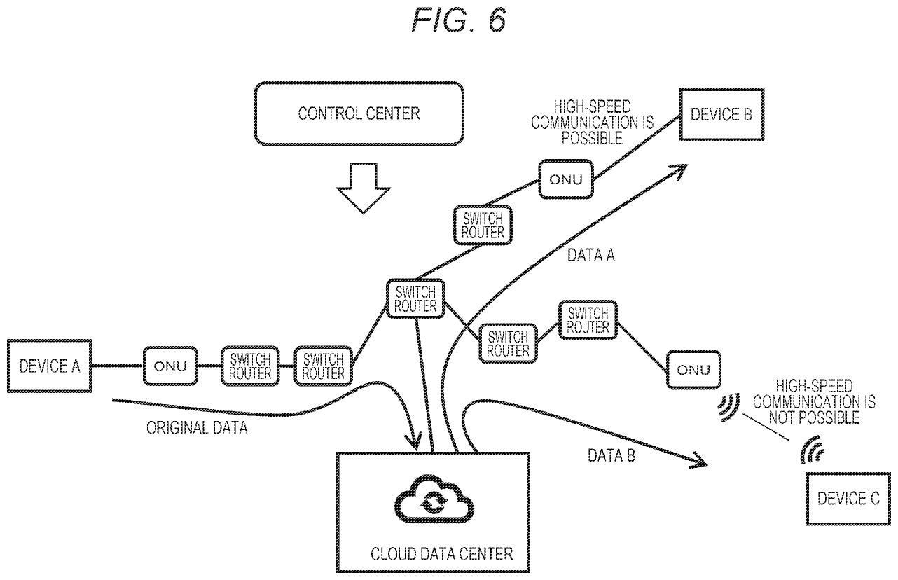

For example, in a case where high-resolution video data is transmitted to a plurality of persons, there is a possibility that enormous data cannot be received depending on a communication speed of a transmission destination network. Therefore, as illustrated in FIG. 6, a technology such as MPEG-dynamic adaptive streaming over HTTP (DASH) supports reception by preparing a plurality of resolution compressed data for original data in a cloud data center and the like on the network and distributing optimal data according to the communication speed of the transmission destination. At that time, since electrical conversion and data processing are required in the cloud data center, an increase in power and an increase in latency occur.

In the present technology, when transmission data is transmitted from a transmission device to a reception device via an optical path as the constructed path (network path), the amount of data is reduced as an optical signal according to the communication speed of the path, and power reduction and latency improvement due to non-electrical conversion are achieved.

### “Configuration Example of Optical Network System”

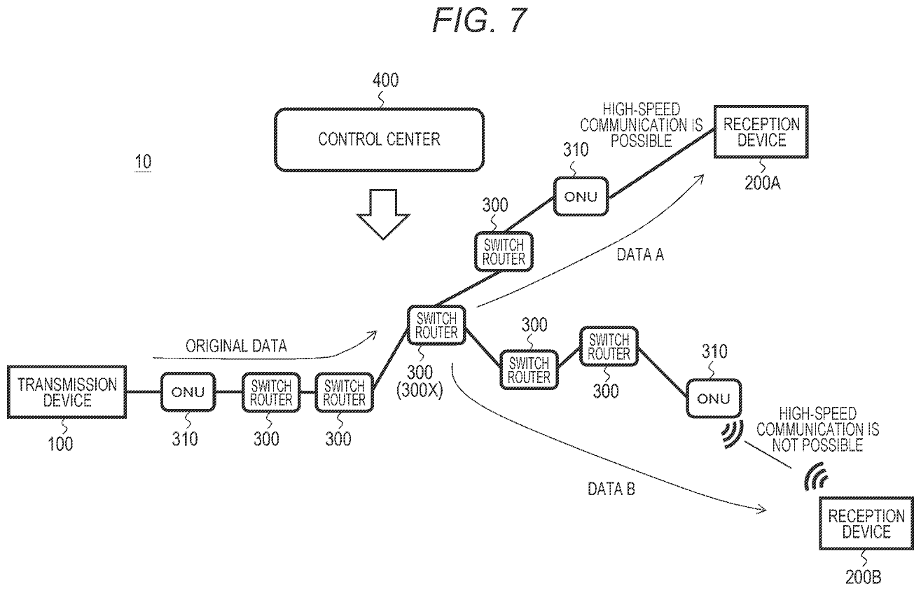

FIG. 7 illustrates a configuration example of an optical network system 10 as an embodiment. The optical network system 10 includes a transmission device 100, a reception device 200A, a reception device 200B, a plurality of switches/routers 300 that forms an optical network present between the transmission device 100 and the reception devices 200A and 200B, and a control center 400 that constructs a path (network path) from the transmission device 100 to the reception devices 200A and 200B.

The control center 400 communicates with the devices and constructs a path by performing connection by optical switching. The switch/router 300 form a relay device. Furthermore, the control center 400 forms an optical network control device. Note that, the transmission device 100 and the reception devices 200A and 200B are each connected to the corresponding switch/router 300 via the ONU 310. Furthermore, in the illustrated example, only the switches/routers 300 included in the path from the transmission device 100 to the reception devices 200A and 200B among the plurality of switches/routers 300 forming the optical network are illustrated in order to simplify the drawing.

At least any one of the predetermined number of switches/routers 300 included in the path from the transmission device 100 to the reception devices 200A and 200B has a function capable of reducing the data amount of the transmission data as the optical signal as it is. In the illustrated example, for example, it is assumed that the switch/router 300 (hereinafter, referred to as a “switch/router 300X”) located at a split point of the transmission data has this function.

A data reduction amount in the path from the transmission device 100 to the reception devices 200A and 200B in the switch/router 300X is controlled by control of the control center 400 on the basis of the communication speed of each path. In this case, the data reduction amount is controlled so as to be within the communication speed of the path; however, in a case where the data amount of original data is within the communication speed of the optical path, the data reduction amount is set to 0. The control center 400 grasps the communication speed of each path on the basis of the communication speed between the respective network devices grasped at the time of initial network construction.

In the illustrated example, since high-speed communication is possible in the path from the transmission device 100 to the reception device 200A, data A with a smaller data reduction amount from the original data is transmitted from the switch/router 300X to the reception device 200A, and on the other hand, since the speed is limited by Wi-Fi communication and the high-speed communication is impossible in the path from the transmission device 100 to the reception device 200B, data B with a larger data reduction amount from the original data is transmitted from the switch/router 300X to the reception device 200B.

In this embodiment, the transmission data transmitted from the transmission device 100 is data the data amount of which can be reduced by thinning, and in a case where the data amount of the transmission data is reduced, the switch/router 300X reduces the data amount by thinning. In this embodiment, a case where the transmission data is video data will be described below, but the data the data amount of which can be reduced by thinning is not limited to the video data.

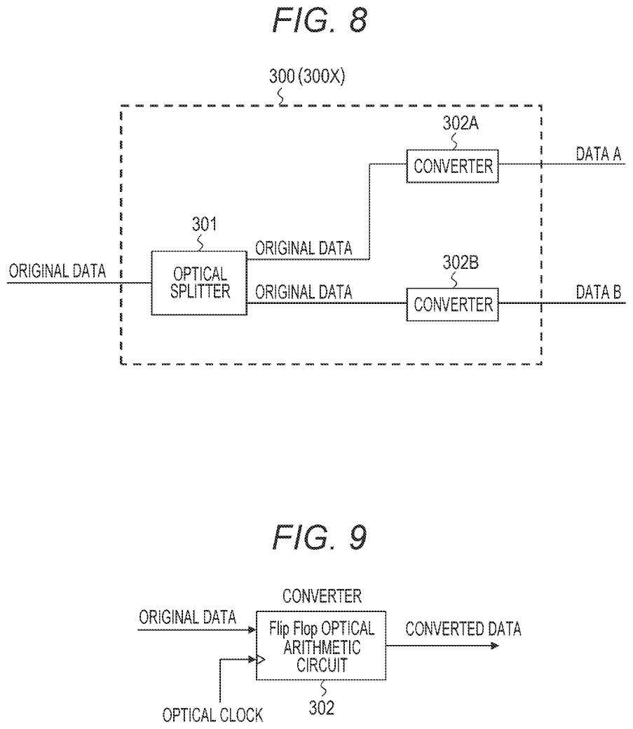

FIG. 8 illustrates a configuration example of the switch/router 300X. In the illustrated example, only a portion related to the path from the transmission device 100 to the reception devices 200A and 200B is illustrated. The switch/router 300X includes an optical splitter 301 and converters 302A and 302B. Each of the converters 302A and 302B forms a data amount conversion unit.

The optical splitter 301 splits the original data as the optical signal. The converter 302A is included in the path from the transmission device 100 to the reception device 200A, reduces the data amount of the original data split by the splitter 301 as the optical signal as it is according to the communication speed of the path, and outputs the same as the data A. The converter 302B is included in the path from the transmission device 100 to the reception device 200B, reduces the data amount of the original data split by the splitter 301 as the optical signal as it is according to the communication speed of the path, and outputs the same as the data B.

FIG. 9 illustrates a configuration example of the converter 302 (302A, 302B). The converter 302 includes, for example, a known flip-flop optical arithmetic circuit detail description of which is omitted. In this case, the original data is input, latched by an optical clock, and converted data is output. In a case where a frequency of the optical clock is the same as a frequency of the original data, the converted data is the same as the original data. On the other hand, in a case where the frequency of the optical clock is lower than the frequency of the original data, thinning is performed on the original data as the converted data, and the data amount of the converted data is reduced from that of the original data.

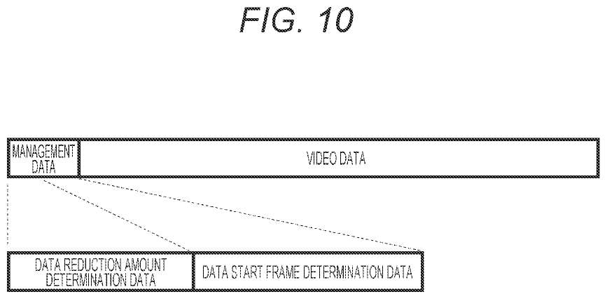

FIG. 10 illustrates a configuration example of the original data as the transmission data transmitted from the transmission device 100. The original data has a configuration in which management data is added to the video data. The management data includes data reduction amount determination data and data start frame determination data. The management data is arranged in a management data period provided immediately before a video data period in which the video data is arranged.

The video data will be described. The video data is subjected to bit data rearrangement processing for thinning. In this embodiment, the bit data rearrangement processing is rearrangement among a plurality of frames, here, among four frames as a set. By rearranging among a plurality of frames as a set in this manner, it is possible to easily reduce the data amount by frame thinning. Note that, as is well known, each frame data includes a vertical synchronization signal, a horizontal synchronization signal, and information such as synchronization information.

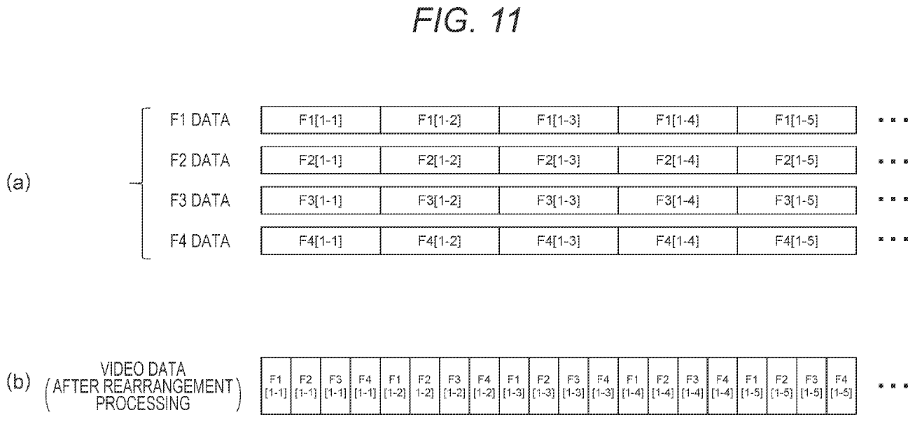

For example, in a case where one pixel is expressed by 10 bits of each of red, green, and blue, each pixel includes 30-bit data. FIG. 11(a) illustrates bit strings of data of four frames of F1, F2, F3, and F4. Here, “Fa [b-c]” indicates bit data of a c-th bit of a b-th pixel of a frame Fa.

FIG. 11(b) illustrates the video data after the bit data rearrangement. In this video data, bit data is sequentially arrayed as F1 [1-1], F2 [1-1], F3 [1-1], F4 [1-1], F1 [1-2], F2 [1-2], F3 [1-2], F4 [1-2], . . . to be data.

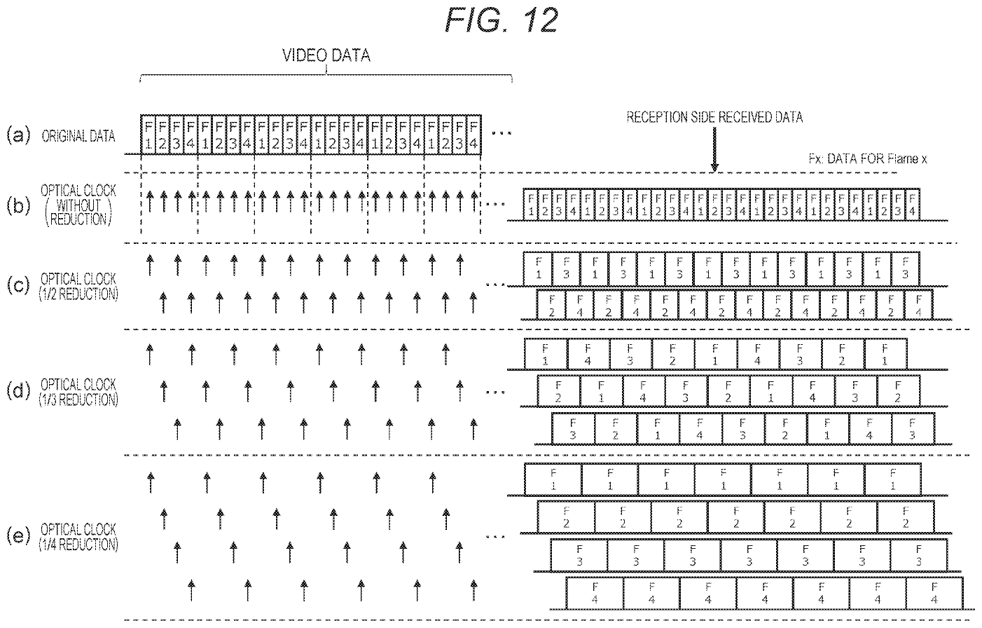

As described above, the data amount reduction by thinning the video data after the bit data rearrangement will be described. FIG. 12(a) illustrates the video data (original data) after the bit data rearrangement, a bit data array of “F1, F2, F3, F4, F1, F2, F3, F4, . . . ”. Here, “Fx” indicates bit data of a frame x.

FIG. 12(b) illustrates a case where the data amount is not reduced, a case where the frequency of the optical clock for thinning is the same as the frequency of the original data. In this case, reception side received data is “F1, F2, F3, F4, F1, F2, F3, F4, . . . ”, and there is no reduction in the data amount.

FIG. 12(c) illustrates a case where the data amount is reduced to ½, a case where the frequency of the optical clock for thinning is ½ of the frequency of the original data. In this case, in a case where there is no phase shift in the optical clock, the reception side received data is “F1, F3, F1, F3, . . . ”, and in a case where there is a phase shift of ½ cycle in the optical clock, the reception side received data is “F2, F4, F2, F4, . . . ”, and in either case, the data amount is reduced to ½.

FIG. 12(d) illustrates a case where the data amount is reduced to ⅓, a case where the frequency of the optical clock for thinning is ⅓ of the frequency of the original data. In this case, in a case where there is no phase shift in the optical clock, the reception side received data is “F1, F4, F3, F2, . . . ”, in a case where there is a phase shift of ⅓ cycle in the optical clock, the reception side received data is “F2, F1, F4, F3, . . . ”, and in a case where there is a phase shift of ⅔ cycle in the optical clock, the reception side received data is “F3, F2, F1, F4, . . . ”, and in either case, the data amount is reduced to ⅓.

FIG. 12(e) illustrates a case where the data amount is reduced to ¼, a case where the frequency of the optical clock for thinning is ¼ of the frequency of the original data. In this case, in a case where there is no phase shift in the optical clock, the reception side received data is “F1, F1, . . . ”, in a case where there is a phase shift of ¼ cycle in the optical clock, the reception side received data is “F2, F2, . . . ”, in a case where there is a phase shift of 2/4 cycle in the optical clock, the reception side received data is “F3, F3, . . . ”, and in a case where there is a phase shift of ¾ cycle in the optical clock, the reception side received data is “F4, F4, . . . ”, and in either case, the data amount is reduced to ¼.

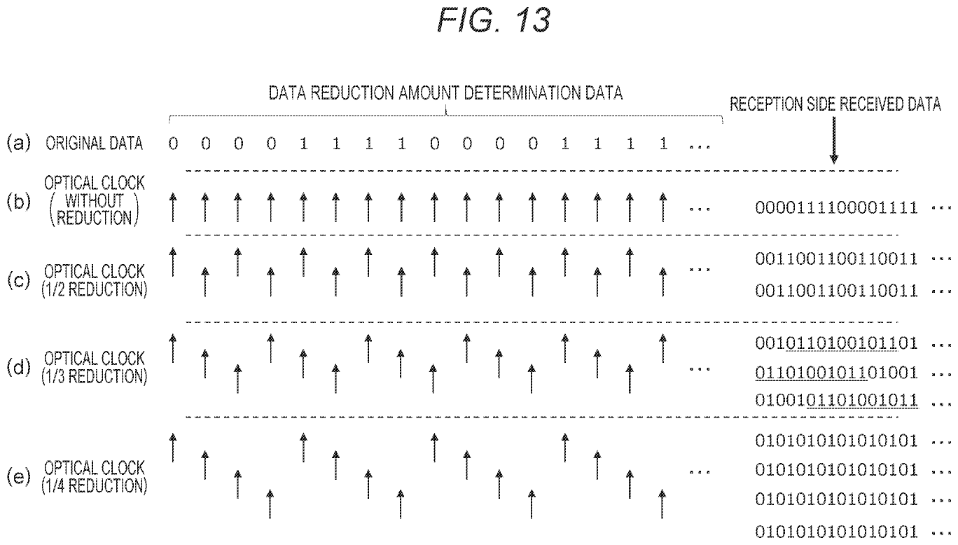

The data reduction amount determination data included in the management data will be described. A period in which the data reduction amount determination data is arranged in the management data period forms a data reduction amount determination period. The data reduction amount determination data is data of a unique bit data array in which a data string indicating a reduction amount is included in a case where the data amount is reduced while being thinned to ½, ⅓, ¼ and the like. In this embodiment, the data reduction amount determination data is, for example, data of a bit data array such as “0000111100001111 . . . ” as illustrated in FIG. 13(a).

FIG. 13(b) illustrates a case where the data amount is not reduced, a case where the frequency of the optical clock for thinning is the same as the frequency of the original data. In this case, the reception side received data is “0000111100001111 . . . ”, and the reception side can determine that the data amount is not reduced.

FIG. 13(c) illustrates a case where the data amount is reduced to ½, a case where the frequency of the optical clock for thinning is ½ of the frequency of the original data. In this case, the reception side received data is “0011001100110011 . . . ”, which is the same even in a case where the phase of the optical clock is shifted by ½ cycle, and the reception side can determine that the data amount is reduced to ½.

FIG. 13(d) illustrates a case where the data amount is reduced to ⅓, a case where the frequency of the optical clock for thinning is ⅓ of the frequency of the original data. In this case, the reception side received data is “0010110100101101··” in a case where there is no phase shift in the optical clock, is “0110100101101001 . . . ” in a case where there is a phase shift of ⅓ cycle in the phase of the optical clock, and is “0100101101001011” in a case where there is a phase shift of ⅔ cycle in the phase of the optical clock. In this manner, in either case, the reception side received data commonly includes, for example, a data string of “01101001011”, and the reception side can determine that the data amount is reduced to ⅓.

FIG. 13(e) illustrates a case where the data amount is reduced to ¼, a case where the frequency of the optical clock for thinning is ¼ of the frequency of the original data. In this case, the reception side received data is “0101010101010101 . . . ”, which is the same even in a case where the phase of the optical clock is shifted by ¼ cycle, 2/4 cycle, and ¾ cycle, and the reception side can determine that the data amount is reduced to

Note that, it is also conceivable that the reception side determines that the data amount is not reduced, is reduced to ½, or is reduced to ¼, and determines that the data amount is reduced to ⅓ in a case other than these cases.

In this manner, by adding the data reduction amount determination data to the video data, the reception side (reception device) can easily determine the data reduction amount by thinning in the received video data, and can appropriately perform processing such as interpolation processing on the transmission data.

The data start frame determination data included in the management data will be described. The data start frame determination data is arranged between the above-described data reduction amount determination data and video data. A period in which the data start frame determination data is arranged in the management data period forms a data start frame determination period.

The data start frame determination data is data including a unique bit data array in which a data string indicating a frame out of the above-described four frames of F1, F2, F3, and F4 bit data of which is the first bit data in a case where the data amount is reduced to ½, ⅓, and ¼ by thinning is included.

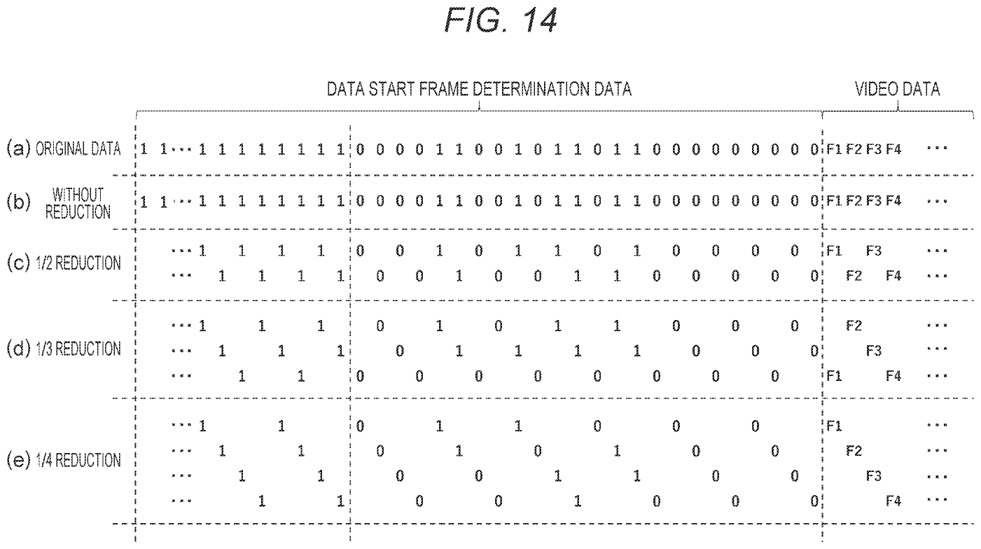

In this embodiment, the data start frame determination data is, for example, data such as “11 . . . 11111111000011001011011000000000” as illustrated in FIG. 14(a), and unique bit data such as “000011001011011000000000” is arrayed after data of the predetermined number of bits “1” is arrayed.

FIG. 14(b) illustrates a case where the data amount is not reduced, a case where the frequency of the optical clock for thinning is the same as the frequency of the original data. In this case, the reception side received data corresponding to the above-described unique bit data array is “000011001011011000000000”, and the reception side can determine that the data start frame is F1 on the basis of the unique bit data string, and can recognize that the frame of each bit data of the video data follows in the order of F1, F2, F3, F4, F1, F2 . . .

FIG. 14(c) illustrates a case where the data amount is reduced to ½, a case where the frequency of the optical clock for thinning is ½ of the frequency of the original data. In this case, in a case where there is no phase shift in the optical clock, the reception side received data corresponding to the above-described unique bit data array is “001011010000”, and the reception side can determine that the data start frame is F1 on the basis of this unique bit data string, and can recognize that the frame of each bit data of the video data follows in the order of F1, F3, F1, F3, . . .

Furthermore, in this case, in a case where there is a phase shift of ½ cycle in the optical clock, the described unique bit data array is “001001100000”, and the reception side can determine that the data start frame is F2 on the basis of this unique bit data string, and can recognize that the frame of each bit data of the video data follows in the order of F2, F4, F2, F4, . . .

FIG. 14(d) illustrates a case where the data amount is reduced to ⅓, a case where the frequency of the optical clock for thinning is ⅓ of the frequency of the original data. In this case, in a case where there is no phase shift in the optical clock, the reception side received data corresponding to the above-described unique bit data array is “00000000”, and the reception side can determine that the data start frame is F1 on the basis of this unique bit data string, and can recognize that the frame of each bit data of the video data follows in the order of F1, F4, F3, F2, F1, F4, F3, F2, . . .

Furthermore, in this case, in a case where there is a phase shift of ⅓ cycle in the optical clock, the reception side received data corresponding to the above-described unique bit data array is “01011000”, and the reception side can determine that the data start frame is F2 on the basis of this unique bit data string, and can recognize that the frame of each bit data of the video data follows in the order of F2, F1, F4, F3, F2, F1, F4, F3, . . .

Furthermore, in this case, in a case where there is a phase shift of ⅔ cycle in the optical clock, the described unique bit data array is “01111000”, and the reception side can determine that the data start frame is F3 on the basis of this unique bit data string, and can recognize that the frame of each bit data of the video data follows in the order of F3, F2, F1, F4, F3, F2, F1, F4, . . .

FIG. 14(e) illustrates a case where the data amount is reduced to ¼, a case where the frequency of the optical clock for thinning is ¼ of the frequency of the original data. In this case, in a case where there is no phase shift in the optical clock, the reception side received data corresponding to the above-described unique bit data array is “011000”, and the reception side can determine that the data start frame is F1 on the basis of this unique bit data string, and can recognize that the frame of each bit data of the video data follows in the order of F1, F1, F1, F1, . . .

Furthermore, in this case, in a case where there is a phase shift of ¼ cycle in the optical clock, the reception side received data corresponding to the above-described unique bit data array is “010100”, and the reception side can determine that the data start frame is F2 on the basis of this unique bit data string, and can recognize that the frame of each bit data of the video data follows in the order of F2, F2, F2, F2, . . .

Furthermore, in this case, in a case where there is a phase shift of 2/4 cycle in the optical clock, the described unique bit data array is “001100”, and the reception side can determine that the data start frame is F3 on the basis of this unique bit data string, and can recognize that the frame of each bit data of the video data follows in the order of F3, F3, F3, F3, . . .

Furthermore, in this case, in a case where there is a phase shift of ¾ cycle in the optical clock, the reception side received data corresponding to the above-described unique bit data array is “001000”, and the reception side can determine that the data start frame is F3 on the basis of this unique bit data string, and can recognize that the frame of each bit data of the video data follows in the order of F4, F4, F4, F4, . . .

In this manner, by adding the frame determination data of the bit data to the video data, the reception side (reception device) can easily determine the frame out of a plurality of frames the bit data of which is the first bit data of the received video data, and can appropriately perform processing such as data accumulation processing and data interpolation processing on the received video data.

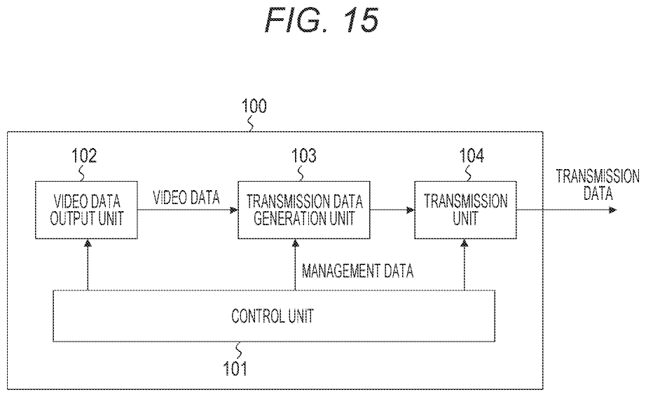

FIG. 15 illustrates a configuration example of the transmission device 100. The transmission device 100 includes a control unit 101, a video data output unit 102, a transmission data generation unit 103, and a transmission unit 104. The control unit 101 controls an operation of each unit of the transmission device 100.

The video data output unit 102 outputs video data to be transmitted. The video data is supplied to the transmission data generation unit 103. Furthermore, the management data including the data reduction amount determination data and the data start frame determination data is supplied from the control unit 101 to the transmission data generation unit 103.

The transmission data generation unit 103 performs bit data rearrangement processing for thinning on the video data supplied from the video data output unit 102 (refer to FIG. 11). Furthermore, the transmission data generation unit 103 adds the management data to the video data after the rearrangement processing to generate the transmission data (refer to FIG. 10). The transmission unit 104 transmits the transmission data generated by the transmission data generation unit 103 to the optical network.

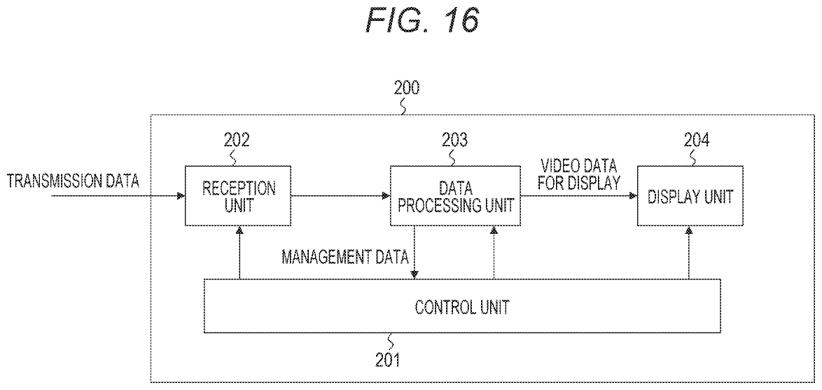

FIG. 16 illustrates a configuration example of the reception device 200 (200A, 200B). The reception device 200 includes a control unit 201, a reception unit 202, a data processing unit 203, and a display unit 204. The control unit 201 controls an operation of each unit of the reception device 200.

The reception unit 202 receives the transmission data transmitted via the optical network. Similarly to the transmission data transmitted from the transmission device 100 illustrated in FIG. 10, the data received by the reception unit 202 is obtained by adding the management data including the data reduction amount determination data and the data start frame determination data to the video data; however, in the switch/router 300X (refer to FIG. 7), the data amount is reduced by thinning as necessary (refer to FIGS. 13 and 14).

The data received by the reception unit 202 is supplied to the data processing unit 203. The data processing unit 203 extracts the management data from the data received by the reception unit 202. The management data is supplied to the control unit 201.

The control unit 201 determines the data reduction amount on the basis of the data reduction amount determination data included in the management data.

Furthermore, the control unit 201 determines the frame the bit data of which is the first bit data of the received video data on the basis of the data start frame determination data included in the management data.

The data processing unit 203 performs processing on the received video data, for example, the data accumulation processing, the data interpolation processing and the like on the basis of the determination result of the control unit 201 described above, and obtains image data for display.

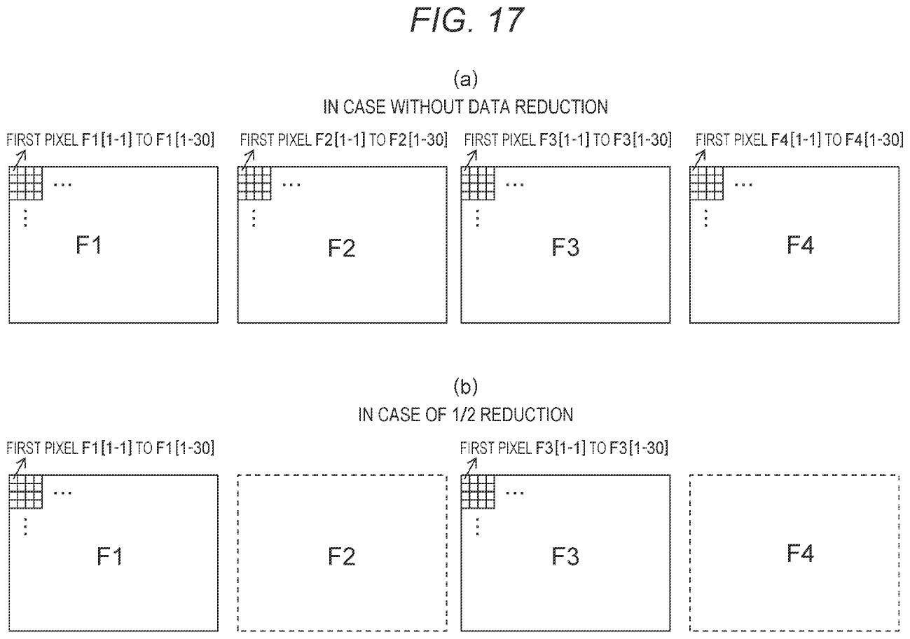

For example, FIG. 17(a) illustrates the video data accumulated in a data buffer in a case where there is no data reduction. Note that, as described above, an example of a case where one pixel is expressed by 10 bits of each of red, green, and blue, and each pixel includes 30-bit data is illustrated.

In this case, the data start frame of the received video data is F1, and the frame of each bit data is F1, F2, F3, F4, F1, F2, . . . . That is, bit data is sequentially arrayed as F1 [1-1], F2 [1-1], F3 [1-1], F4 [1-1], F1 [1-2], F2 [1-2], F3 [1-2], F4 [1-2], . . . to be data (refer to FIG. 11(b)).

The data processing unit 203 sequentially accumulates the bit data of each of the received video data in the corresponding pixel position of the corresponding frame buffer, and the video data of each frame of F1, F2, F3, and F4 is reconstructed as illustrated in FIG. 17(a). In this case, processing opposite to the bit rearrangement processing in the transmission device 100 is performed. Then, the data processing unit 203 sequentially reads the video data of each frame accumulated in the data buffer in this manner, and outputs the same as the video data for display.

Furthermore, for example, FIG. 17(b) illustrates the video data accumulated in the data buffer in a case where the data amount is reduced to ½. In this case, in the received video data, for example, a data start frame is F1, and the frame of each bit data is F1, F3, F1, F3, . . . . That is, the bit data is sequentially arrayed as F1 [1-1], F3 [1-1], F1 [1-2], F3 [1-2], . . . to be data.

The data processing unit 203 sequentially accumulates the bit data of each of the received video data in the corresponding pixel position of the corresponding frame buffer, and the video data of each frame of F1 and F3 is reconstructed as illustrated in FIG. 17(b). Then, the data processing unit 203 sequentially reads the video data of each frame accumulated in the data buffer in this manner, and sets the same as the video data for display as it is, or further interpolates the video data of the frames F2 and F4 by interpolation processing, and then outputs the same as the video data for display.

Note that, in a case where the data amount is reduced to ⅓ or ¼, the detailed description is omitted, but similarly to the above-described case where the data amount is reduced to ½, the data processing unit 203 sequentially accumulates each bit data of the received video data in a corresponding pixel position of a corresponding frame buffer, and performs the data interpolation processing as necessary to obtain the video data for display.

Returning to FIG. 16, the video data for display obtained by the data processing unit 203 is supplied to the display unit 204. The display unit 204 displays the video on the basis of the video data for display supplied from the data processing unit 203.

As described above, in the optical network system 10 illustrated in FIG. 7, the switch/router 300X included in the path formed by the control center 400 is configured to reduce the data amount of the transmission data as the optical signal as it is, and the data reduction amount is controlled by the control center 400 on the basis of the communication speed of the path. Therefore, it is possible to convert the transmission data from the transmission device 100 into the data amount corresponding to the communication speed of the path and transmit the same to the reception devices 200A and 200B without causing an increase in power or latency.

### <2. Variation>

Note that, in the above-described embodiment, an example has been described in which the video data transmitted from the transmission device 100 is rearranged among a plurality of frames, for example, four frames as a set as the bit data rearrangement processing for performing thinning. However, the rearrangement processing to be performed on the video data in order to perform thinning is not limited thereto.

For example, it is also conceivable to set a plurality of pixels, for example, four pixels (2×2) or 16 pixels (4×4) and to perform rearrangement among these pixels as the rearrangement processing to be performed on the video data in order to perform thinning. By rearranging among a plurality of pixels as a set in this manner, it is possible to easily reduce the data amount by thinning the pixel.

For example, in a case where 16 pixels (4×4) are set and the pixels are rearranged among them, for 8K video data, for example, this can be transmitted as 8K video data as it is in a case where there is no thinning and no reduction in the data amount, transmitted as 4K video data in a case where the data amount is reduced to ¼ by thinning, and further transmitted as 2K video data in a case where the data amount is reduced to 1/16 by thinning.

Furthermore, in the above-described embodiment, an example is described in which the control center 400 controls the data reduction amount in the path from the transmission device 100 to the reception devices 200A and 200B in the switch/router 300X on the basis of the communication speed of each path. However, it is conceivable that the control center 400 also controls capabilities of the reception devices 200A and 200B. Here, the capabilities of the reception devices 200A and 200B include, for example, data processing capability, data accumulation capability, video display capability and the like.

For example, in a case where a frame rate of the video data as the original data transmitted from the transmission device is 120 Hz, even if high-speed communication supporting the transmission of the video data of 120 Hz is possible as the communication speed of the path from the transmission device 100 to the reception device 200A, if the reception device 200A can process only the video data of up to 60 Hz, the control center 400 controls to make the data reduction amount in the path from the transmission device 100 to the reception device 200A in the switch/router X to ½ reduction (reduce to make the data amount ½).

Furthermore, for example, in a case where the video data as the original data transmitted from the transmission device is 8K video data, even if high-speed communication supporting the transmission of the 8K video data is possible as the communication speed of the path from the transmission device 100 to the reception device 200A, if the reception device 200A can display only 4K video, the control center 400 controls to make the data reduction amount in the path from the transmission device 100 to the reception device 200A in the switch/router 300X to ¼ reduction (reduce to make the data amount ¼).

In this manner, the control center 400 controls the data reduction amount of each path in the switch/router 300X on the basis of capabilities of the reception devices 200A and 200B together with the communication speed of the path from the transmission device 100 to the reception devices 200A and 200B, so that more appropriate control can be performed in consideration of the capabilities of the reception devices 200A and 200B, wasteful data transmission can be suppressed, and wasteful use of network resources and wasteful use of power can be eliminated.

Furthermore, the preferred embodiment of the present disclosure has been described in detail with reference to the accompanying drawings, but the technical scope of the present disclosure is not limited to such example. It is apparent that a person having ordinary knowledge in the technical field of the present disclosure can achieve various variations or modifications within the scope of the technical idea recited in claims, and it will be naturally understood that they also belong to the technical scope of the present disclosure.

Furthermore, the effects described in the present specification are merely exemplary or illustrative, and not restrictive. That is, the technology according to the present disclosure can exhibit other effects apparent to those skilled in the art from the description of the present specification, in addition to the effects described above or instead of the effects described above.

Furthermore, the present technology can also have the following configurations.

(1) An optical network system including:
a transmission device; a reception device; a plurality of relay devices present between the transmission device and the reception device; and an optical network control device that constructs a path from the transmission device to the reception device, in which
at least any one of a predetermined number of the relay devices included in the constructed path includes a data amount conversion unit configured to reduce a data amount of transmission data as an optical signal as it is, and
the optical network control device controls a data reduction amount in the data amount conversion unit on the basis of a communication speed of the constructed path.

(2) The optical network system according to (1) described above, in which the transmission data transmitted from the transmission device is data the data amount of which is able to be reduced by thinning, and in a case where the data amount of the transmission data is reduced, the data amount conversion unit reduces the data amount by thinning.

(3) The optical network system according to (2) described above, in which management data for enabling the reception device to determine a data reduction amount by the thinning in the transmission data received by the reception device is added to the transmission data transmitted from the transmission device.

(4) The optical network system according to (2) or (3) described above, in which
the transmission data transmitted from the transmission device is video data subjected to bit data rearrangement processing for performing the thinning.

(5) The optical network system according to (4) described above, in which
the bit data rearrangement processing is rearrangement of bit data between a plurality of frames as a set or between a plurality of pixels as a set in a frame.

(6) The optical network system according to (5) described above, in which
management data for enabling the reception device to determine a frame out of the plurality of frames the bit data of which is first bit data received by the reception device in a case where the bit data rearrangement processing is the rearrangement between the plurality of frames as a set is added to the transmission data transmitted from the transmission device.

(7) The optical network system according to any one of (1) to (6), in which
the optical network control device controls a data reduction amount in the data amount conversion unit on the basis of a capability of the reception device together with the communication speed of the constructed path.

(8) A relay device, including:
a data amount conversion unit that converts a data amount of transmission data, in which
the data amount conversion unit is configured to reduce the data amount of the transmission data as an optical signal as it is.

(9) The relay device according to (8) described above, in which
the data amount conversion unit is formed by using an optical arithmetic circuit.

(10) The relay device according to (8) or (9) described above, in which
the data amount conversion unit reduces the data amount by thinning in a case of reducing the data amount of the transmission data.

(11) The relay device according to any one of (8) to (10) described above, further including:
an optical splitter, in which
the data amount conversion unit converts the data amount of the transmission data split by the optical splitter.

(12) A transmission device including:
a data output unit that outputs transmission data a data amount of which is able to be reduced by thinning;
and a data transmission unit that transmits the transmission data.

(13) The transmission device according to (12) described above, in which
management data for enabling a reception device to determine a data reduction amount by the thinning in the transmission data received by the reception device is added to the transmission data.

(14) The transmission device according to (12) or (13) described above, in which
the transmission data is video data subjected to bit data rearrangement processing for performing the thinning.

(15) The transmission device according to (14) described above, in which
the bit data rearrangement processing is rearrangement of bit data between a plurality of frames as a set or between a plurality of pixels as a set in a frame.

(16) The transmission device according to (15) described above, in which
management data for enabling a reception device to determine a frame out of the plurality of frames the bit data of which is first bit data received by the reception device in a case where the bit data rearrangement processing is the rearrangement between the plurality of frames as a set is added to the transmission data.

(17) A reception device including:
a data reception unit that receives transmission data to which management data for determining a data reduction amount is added;
a determination unit that determines the data reduction amount on the basis of the management data; and
a data processing unit that processes the received transmission data on the basis of the determined data reduction amount.

(18) The reception device according to (17) described above, in which
the received transmission data is transmission data transmitted via a data conversion unit configured to reduce a data amount by thinning as an optical signal as it is.

(19) An optical network control device including:
a path construction unit that constructs a path from a transmission device to a reception device via a predetermined number of relay devices on an optical network, in which
at least any one of the predetermined number of relay devices included in the constructed path includes a data amount conversion unit configured to reduce a data amount of transmission data as an optical signal as it is, and
further includes a data reduction amount control unit that controls a data reduction amount in the data amount conversion unit on the basis of a communication speed of the constructed path.

(20) The optical network control device according to (19) described above, in which
the data reduction amount control unit controls the data reduction amount in the data amount conversion unit on the basis of a capability of the reception device together with the communication speed of the constructed path.

### REFERENCE SIGNS LIST

10 Optical network system
100 Transmission device
101 Control unit
102 Video data output unit
103 Transmission data generation unit
104 Transmission unit
200, 200A, 200B Reception device
201 Control unit
202 Reception unit
203 Data processing unit
204 Display unit
300, 300X Switch/router
301 Optical splitter
302, 302A, 302B Converter
310 ONU
400 Control center

1. An optical network system comprising:
a transmission device; a reception device; a plurality of relay devices present between the transmission device and the reception device; and an optical network control device that constructs a path from the transmission device to the reception device, wherein
at least any one of a predetermined number of the relay devices included in the constructed path includes a data amount conversion unit configured to reduce a data amount of transmission data as an optical signal as it is, and
the optical network control device controls a data reduction amount in the data amount conversion unit on a basis of a communication speed of the constructed path.

2. The optical network system according to claim 1, wherein
the transmission data transmitted from the transmission device is data the data amount of which is able to be reduced by thinning, and
in a case where the data amount of the transmission data is reduced, the data amount conversion unit reduces the data amount by thinning.

3. The optical network system according to claim 2, wherein
management data for enabling the reception device to determine a data reduction amount by the thinning in the transmission data received by the reception device is added to the transmission data transmitted from the transmission device.

4. The optical network system according to claim 2, wherein
the transmission data transmitted from the transmission device is video data subjected to bit data rearrangement processing for performing the thinning.

5. The optical network system according to claim 4, wherein
the bit data rearrangement processing is rearrangement of bit data between a plurality of frames as a set or between a plurality of pixels as a set in a frame.

6. The optical network system according to claim 5, wherein
management data for enabling the reception device to determine a frame out of the plurality of frames the bit data of which is first bit data received by the reception device in a case where the bit data rearrangement processing is the rearrangement between the plurality of frames as a set is added to the transmission data transmitted from the transmission device.

7. The optical network system according to claim 1, wherein
the optical network control device controls a data reduction amount in the data amount conversion unit on a basis of a capability of the reception device together with the communication speed of the constructed path.

8. A relay device, comprising:
a data amount conversion unit that converts a data amount of transmission data, wherein
the data amount conversion unit is configured to reduce the data amount of the transmission data as an optical signal as it is.

9. The relay device according to claim 8, wherein
the data amount conversion unit is formed by using an optical arithmetic circuit.

10. The relay device according to claim 8, wherein
the data amount conversion unit reduces the data amount by thinning in a case of reducing the data amount of the transmission data.

11. The relay device according to claim 8, further comprising:
an optical splitter, wherein
the data amount conversion unit converts the data amount of the transmission data split by the optical splitter.

12. A transmission device comprising:
a data output unit that outputs transmission data a data amount of which is able to be reduced by thinning; and
a data transmission unit that transmits the transmission data.

13. The transmission device according to claim 12, wherein
management data for enabling a reception device to determine a data reduction amount by the thinning in the transmission data received by the reception device is added to the transmission data.

14. The transmission device according to claim 12, wherein
the transmission data is video data subjected to bit data rearrangement processing for performing the thinning.

15. The transmission device according to claim 14, wherein
the bit data rearrangement processing is rearrangement of bit data between a plurality of frames as a set or between a plurality of pixels as a set in a frame.

16. The transmission device according to claim 15, wherein
management data for enabling a reception device to determine a frame out of the plurality of frames the bit data of which is first bit data received by the reception device in a case where the bit data rearrangement processing is the rearrangement between the plurality of frames as a set is added to the transmission data.

17. A reception device comprising:
a data reception unit that receives transmission data to which management data for determining a data reduction amount is added;
a determination unit that determines the data reduction amount on a basis of the management data; and
a data processing unit that processes the received transmission data on a basis of the determined data reduction amount.

18. The reception device according to claim 17, wherein
the received transmission data is transmission data transmitted via a data conversion unit configured to reduce a data amount by thinning as an optical signal as it is.

19. An optical network control device comprising:
a path construction unit that constructs a path from a transmission device to a reception device via a predetermined number of relay devices on an optical network, wherein
at least any one of the predetermined number of relay devices included in the constructed path includes a data amount conversion unit configured to reduce a data amount of transmission data as an optical signal as it is, and
further includes a data reduction amount control unit that controls a data reduction amount in the data amount conversion unit on a basis of a communication speed of the constructed path.

20. The optical network control device according to claim 19, wherein
the data reduction amount control unit controls the data reduction amount in the data amount conversion unit on a basis of a capability of the reception device together with the communication speed of the constructed path.
